(19) United States
(12) Patent Application Publication
(10) Pub. No.: US 2014/0344750 A1
(43) Pub. Date: Nov. 20, 2014

(54) DISPLAY DEVICE AND DISPLAY METHOD

(71) Applicant: Panasonic Corporation, Osaka (JP)

(72) Inventors: Masaki Takahashi, Osaka (JP); Ryo Yokoyama, Kanagawa (JP)

(21) Appl. No.: 14/370,172

(22) PCT Filed: Dec. 26, 2012
(86) PCT No.: PCT/JP2012/008334

§ 371 Date: Jul. 1, 2014

(30) Foreign Application Priority Data
Jan. 18, 2012 (JP) 2012-007977

(51) Int. Cl. G06F 3/0481; G06F 3/0484

(52) U.S. Cl. CPC G06F 3/0481; G06F 3/04842
USPC 715/790

(57) ABSTRACT

Provided is a display device with which it is possible for a plurality of users to comfortably carry out different window manipulations without a screen being partitioned. This device (100), which displays a plurality of windows on one screen, comprises: an active window administration unit (260) which administers an association between at least an active window among a plurality of windows, and a user who is manipulating the active window; and a window control unit (270) which controls the display state of the active window on the basis of the association. When there is a plurality of users present, the window control unit (270) controls the display locations of a plurality of active windows corresponding to the plurality of users such that the plurality of active windows are not superpositioned.

### TECHNICAL FIELD

The present invention relates to a display apparatus and a display method in which a plurality of users can operate a plurality of windows on a single screen.

### BACKGROUND ART

Heretofore, display apparatuses configured to display a plurality of windows on a single screen have been mainly used by single users (e.g., personal computers (PCs)). However, the introduction of large-screen touch operation screens in recent years has spurred widespread of display apparatuses that allow multiple users to use the display apparatus, simultaneously. Examples of such a display apparatus (hereinafter, referred to as a “multi-user operable display apparatus”) include a tablet PC and a liquid crystal display (LCD) with a table-type touch panel.

Such a multi-user operable display apparatus allows a plurality of users not only to work together using the same window but also to work using different windows. When a plurality of users operate different windows at the same time, it is desirable to allow each window operation to be performed with comfort without being interrupted by another operation.

In this regard, a technique disclosed in Patent Literature (hereinafter, abbreviated as PTL) 1 (hereinafter, referred to as “related art”) allows for detection of a face position of each user and division of a screen for each user based on the detected face position of the user. According to the related art, it is possible to prevent a plurality of window operations from interfering with one another. Further, a plurality of users can perform the respective window operations with comfort without being interrupted by the window operation of another user.

### CITATION LIST

### Patent Literature

PTL 1
Japanese Patent Application Laid-Open No. 2011-54069

### SUMMARY OF INVENTION

### Technical Problem

In the related art, however, each user can use only a very limited and narrow region as compared to the original screen size. For this reason, there is a demand for a technique enabling a plurality of users to perform individual window operations with comfort on a non-divided screen in multi-user operable display apparatus.

It is an object of the present invention to enable a plurality of users to perform individual window operations with comfort on a non-divided screen.

### Solution to Problem

A display apparatus according to an aspect of the present invention is an apparatus that displays a plurality of windows on a single screen, the apparatus including: an active window managing section that manages an association between at least an active window among the plurality of windows and a user operating the active window; and a window control section that controls a display state of the active window based on the association, in which the window control section controls, when a plurality of the users are present, display positions of a plurality of the active windows so as to prevent the plurality of active windows corresponding to the plurality of users from overlapping each other.

A display method according to an aspect of the present invention is a method of displaying a plurality of windows on a single screen, the method including: associating at least an active window among the plurality of windows with a user operating the active window; and controlling, when a plurality of the users are present, display positions of the plurality of active windows so as to prevent the plurality of active windows corresponding to the plurality of users from overlapping each other.

### Advantageous Effects of Invention

According to the present invention, a plurality of users can perform individual window operations with comfort on a non-divided screen.

### BRIEF DESCRIPTION OF DRAWINGS

FIG. 1 is a block diagram illustrating an exemplary configuration of a display apparatus according to Embodiment 1 of the present invention;

FIG. 2 is a block diagram illustrating an exemplary configuration of a terminal apparatus according to Embodiment 2 of the present invention;

FIG. 3 is a flowchart illustrating an exemplary operation of a terminal apparatus according to Embodiment 2 of the present invention;

FIG. 4 is a diagram illustrating an exemplary content of user information according to Embodiment 2 of the present invention;

FIG. 5 is a diagram illustrating an exemplary method of determining an operation region according to Embodiment 2 of the present invention;

FIG. 6 is a diagram illustrating another exemplary method of determining an operation region according to Embodiment 2 of the present invention;

FIG. 7 is a diagram illustrating examples of the position of a user, an operation region, and a display screen according to Embodiment 2 of the present invention;

FIG. 8 is a diagram illustrating an exemplary content of association information according to Embodiment 2 of the present invention;

FIG. 9 is a diagram illustrating an exemplary content of active window information according to Embodiment 2 of the present invention;

FIG. 10 is a flowchart illustrating an exemplary display state control process according to Embodiment 2 of the present invention;

FIG. 11 is a block diagram illustrating an exemplary configuration of a terminal apparatus according to Embodiment 3 of the present invention;

FIG. 12 is a diagram illustrating an example of how a display form is reconfigured in Embodiment 3 of the present invention; and

FIG. 13 is a diagram illustrating an example of a search range for free space according to Embodiment 2 or 3 of the present invention.

### DESCRIPTION OF EMBODIMENTS

Hereinafter, exemplary embodiments of the present invention will be described in detail with reference to the appended drawings.

### Embodiment 1

Embodiment 1 of the present invention is an example of a basic mode of the present invention.

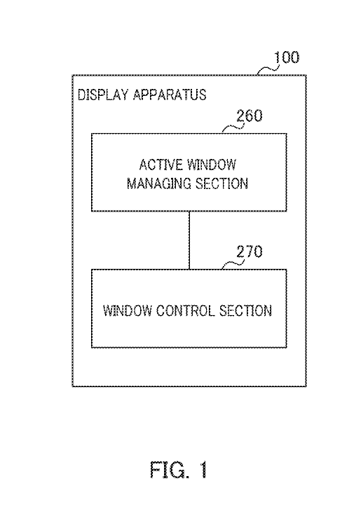

FIG. 1 is a block diagram illustrating an exemplary configuration of a display apparatus according to the present embodiment.

Referring to FIG. 1, display apparatus 100 is an apparatus configured to display a plurality of windows on a single screen and including active window managing section 260 and window control section 270.

Active window managing section 260 manages an association between at least an active window among a plurality of windows and a user operating the active window.

Window control section 270 controls a display state of the active window based on the association. More specifically, when there are a plurality of users, window control section 270 controls display positions of a plurality of active windows corresponding to the plurality of users such that the plurality of active windows do not overlap each other.

Further, although not shown, display apparatus 100 includes, for example, a Central Processing Unit (CPU), a storage medium such as a Read Only Memory (ROM) storing a control program, and a working memory such as a Random Access Memory (RAM). In this case, the functions of the respective sections are implemented by the CPU executing the control program.

Display apparatus 100 can manage each active window in association with a user operating the corresponding active window, and manage a display state based on this association. Thus, it is made possible to perform a process of preventing the active windows operated by a plurality of users from overlapping each other. Accordingly, display apparatus 100 allows a plurality of users to perform individual window operations with comfort on a non-divided screen.

### Embodiment 2

Embodiment 2 of the present invention is an example in which the present invention is applied to a terminal apparatus including a relatively large screen with a touch panel such as a tablet PC.

<Configuration of Terminal Apparatus>

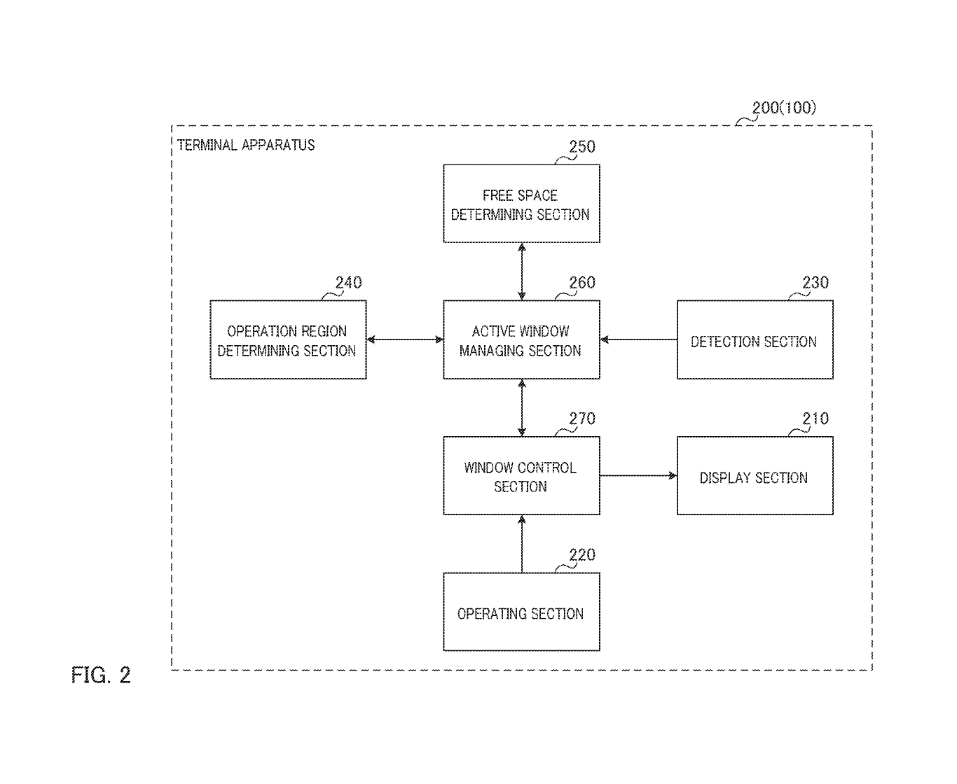

FIG. 2 is a block diagram illustrating an exemplary configuration of a terminal apparatus including a display apparatus according to the present embodiment.

Terminal apparatus 200 (display apparatus 100) is an apparatus configured to display a plurality of windows on a single screen. Terminal apparatus 200 includes display section 210, operating section 220, detection section 230, operation region determining section 240, free space determining section 250, active window managing section 260, and window control section 270.

Display section 210 displays a screen for the user. Specifically, display section 210 includes an LCD. Further, display section 210 generates an image based on image data input from window control section 270, which will be described later, and displays a plurality of windows on an LCD screen.

In the present embodiment, the term “window” refers to an independent display region where an image or a document can be displayed and a position change operation such as movement, enlargement, or rotation can be performed. A window used in Windows (a registered trademark) or Mac OS (a registered trademark) is a representative of such a display region.

In the following description, a window serving as the operation target of the user is referred to as an “active window.” Further, a window that is not the operation target of the user is referred to as an “inactive window.”

At each point in time, the number of active windows for each user is assumed to be one. When a new window is generated, the generated window becomes an active window at that point in time. Further, when the user starts an operation on a window other than the active window, the previous active window becomes an inactive window. Active window managing section 260 to be described later manages information related to the state of each window.

Operating section 220 receives the operation of the user on the screen. Specifically, operating section 220 is a touch panel installed on the LCD of display section 210. Operating section 220 detects the touch operation of the user each time the touch operation is performed, and outputs an operation signal indicating the position where the touch operation is performed to window control section 270.

Detection section 230 detects the position of the user on the screen. Specifically, detection section 230 includes a camera (omnidirectional, wide-angle or fisheye camera, or a plurality of cameras) or a sensor such as a distance measurement sensor (light-beam or radio frequency sensor). Further, detection section 230 detects the position of each user and identification information.

In the present embodiment, an assumption is made that the face image of each user is used as the identification information of the user. Detection section 230 outputs information indicating a set of the identification information of each user and relative coordinates (hereinafter, referred to simply as “coordinates”) of the detected position of each user on the screen (hereinafter, referred to as “user information”) to active window managing section 260. The user information is held in active window managing section 260.

Here, the position of each user refers to a position serving as a reference for determining a range and a direction of a window on the screen in which the user can easily perform an operation.

For example, the position of a user is a position of a vertical projection point of a center position of the face in a plane including the screen. In this case, for example, a spatial position of the user's face can be acquired based on an image recognition processing result on a photographed image taken by an omnidirectional camera installed upward near the screen, and a camera parameter.

Further, for example, the position of a user is a position of the body of the user on a plane including the screen. In this case, for example, a spatial position of the body of the user can be acquired based on object detection by a distance measurement sensor installed near the screen.

Further, detection section 230 may detect the position of each user and identification information based on an operation received through operating section 220. The identification information of a user may be biological information such as a feature point of a face or a fingerprint, or authentication information such as a password input by the user.

Operation region determining section 240 determines an operation region of each user. Specifically, operation region determining section 240 determines the operation region of each user based on the user information held in active window managing section 260. In the present embodiment, operation region determining section 240 determines a rectangular region of a predetermined size at a position near each user at an angle according to an angle of each user as the operation region.

Here, for example, the angle of a user refers to an angle corresponding to a direction from the face position of the user toward the center of the screen. In other words, operation region determining section 240 determines a region in which each user can easily perform an operation as the operation region for each user.

Further, operation region determining section 240 outputs information indicating a set of the identification information of each user and coordinates of the determined operation region of each user (hereinafter, referred to as “operation region information”) to active window managing section 260. The operation region information is held in active window managing section 260.

Further, operation region determining section 240 may determine the operation region of each user and acquire the identification information based on an operation received through operating section 220. Further, a plurality of operation regions determined in association with a plurality of users may overlap each other.

Free space determining section 250 determines a free space. Specifically, free space determining section 250 identifies coordinates of a free space based on coordinates of each window described in association information managed by active window managing section 260, which will be described later, and the size of the screen. Further, free space determining section 250 outputs information indicating coordinates of a free space (hereinafter, referred to as “free space information”) to active window managing section 260. The free space information is held in active window managing section 260.

Here, the term “free space” refers to a region where no window is displayed, e.g., a region where a background image of the screen is displayed.

Active window managing section 260 manages an association between at least an active window among a plurality of windows and a user operating the active window, and the operation region of the user on the screen. At this time, active window managing section 260 associates the active window with the user based on at least one of the operation and position of the user.

Specifically, active window managing section 260 generates association information based on the user information, the operation region information, and window information and operation information input from window control section 270, which will be described later, and manages the generated association information.

The window information is information indicating coordinates of each window and whether or not each window is an active window. The association information is information indicating an association between the active window and the user operating the active window, and the operation region of each user. In other words, the association information is information indicating an association between the position of the active window and the position of the operation region for each user.

For example, an ID assigned to each user can be used for an association between the user and other information. Further, for example, an ID assigned to each window can be used for identification of a window.

Window control section 270 performs generation of a new window, switching between displaying a generated window and not displaying the same, a window process on a window being displayed, and the like based on an operation signal input from operating section 220. Further, window control section 270 combines images in which a plurality of windows are arranged at desired positions, and outputs image data of a combined image to display section 210.

Here, the window process refers to a process of changing a display form or display content of a window such as movement, rotation, scaling, information input and/or editing of a text, an image, and the like on a window.

Further, every time the user operation is performed on the screen, window control section 270 generates the window information and operation information, and outputs the window information and operation information to active window managing section 260.

Here, the window information is information indicating coordinates of each window and whether or not each window is an active window as described above. The operation information is information indicating what operation is performed at which position and for which window. Specifically, for example, the operation information is information indicating an operation performed in the window process.

Further, window control section 270 controls the display state of the active window based on an association between the active window and the user managed by active window managing section 260. Specifically, when there are a plurality of users, and a plurality of active windows corresponding to the plurality of users overlap each other, window control section 270 moves at least one of the plurality of active windows according to a predetermined rule. Window control section 270 performs such window control according to an instruction given from active window managing section 260.

Here, the term “predetermined rule” refers to a rule that controls display positions of a plurality of active windows so as to prevent the plurality of active windows from overlapping each other. Specifically, the predetermined rule is a rule that makes, in each operation region, the active window of the user of the operation region positioned within the operation region of the user preferentially over another active window.

For example, the predetermined rule includes a rule that prevents, in each operation region, the active window of the user of the operation region currently positioned in the operation region of the user from moving out of the corresponding operation region.

Further, for example, the predetermined rule includes a rule that makes, in each operation region, the active window of the user of the operation region not positioned in the operation region of the user move to the corresponding operation region.

Further, for example, the predetermined rule includes a rule that determines, when a free space is present, preferentially a region involving a smaller moving distance from the active window and/or a region having a larger area among the free space as the moving destination of the active window.

Further, for example, the predetermined rule includes a rule that makes a display position of an active window of a predetermined type not move as much as possible, the active window of the predetermined type being an active window whose display position should remain the same. For example, the predetermined type of active window whose display position should remain the same is an active window in an operation state other than movement, enlargement, rotation, and no operation, which will be described later.

The inactive window is likely to overlap behind another window. However, the inactive window is not an operation target at that point in time. For this reason, even when another window overlaps on top of the inactive window, the comfort of the user operation is hardly impaired.

Further, in the present embodiment, active window managing section 260 determines how the active window moves. In other words, window control section 270 follows the determination made by active window managing section 260, and performs display control according to the predetermined rule described above.

Active window managing section 260 outputs window control information including an angle of each window and a movement instruction to window control section 270. The window control information is information indicating a set of identification information and an angle of a window, and a position after movement as appropriate for each window.

Further, although not shown, terminal apparatus 200 includes a CPU, a storage medium such as a ROM storing a control program, and a working memory such as a RAM. In this case, the functions of the respective sections are implemented by the CPU executing the control program.

Terminal apparatus 200 manages each active window in association with the user operating the corresponding active window, and prevents the active windows operated by a plurality of users not from overlapping each other. As a result, terminal apparatus 200 allows each user to perform a task using the screen to the maximum extent and prevents the active windows of the users from overlapping each other. Thus, terminal apparatus 200 allows a plurality of users to perform individual window operations with comfort on the non-divided screen.

<Operation of Terminal Apparatus>

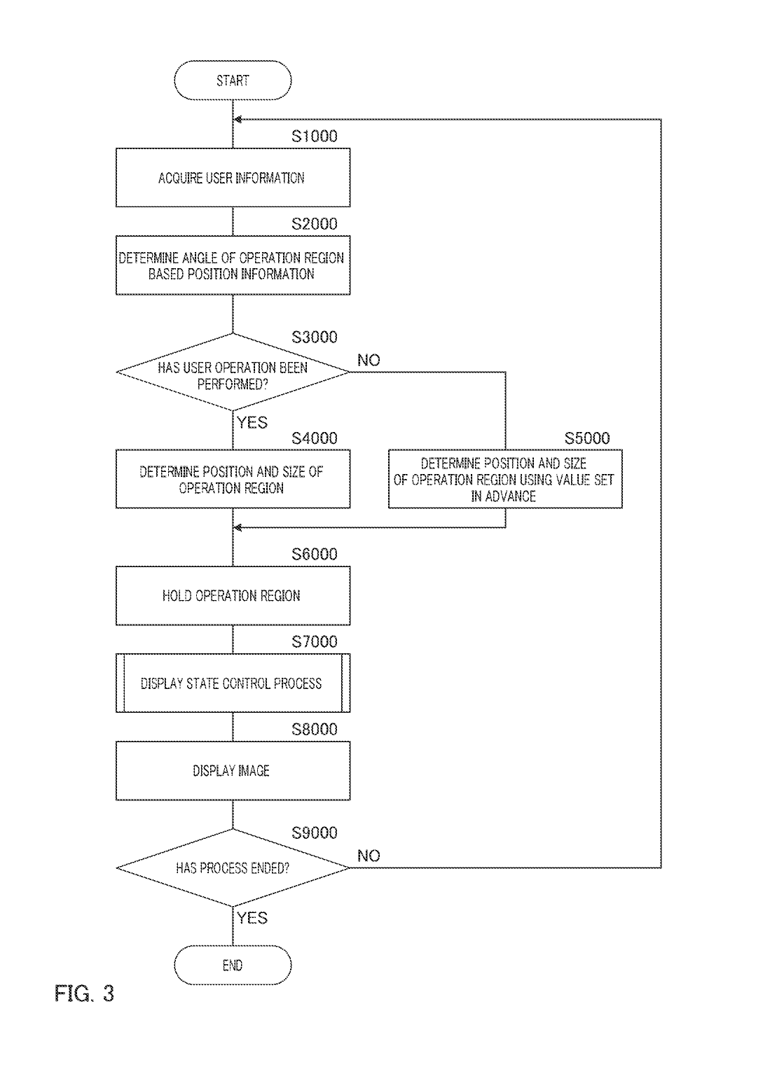

FIG. 3 is a flowchart illustrating an exemplary operation of terminal apparatus 200.

During the operation illustrated in FIG. 3, display section 210, operating section 220, detection section 230, and free space determining section 250 continuously perform the processing of displaying image data, receiving an operation, detecting the user, and determining the free space. Further, terminal apparatus 200 separately performs processing corresponding to the window operation, but a description of such processing is omitted hereinafter. Here, an assumption is made that two users are operating terminal apparatus 200 at the same time.

First, in step S1000, detection section 230 detects the user's face, and generates user information. Detection section 230 outputs the generated user information to active window managing section 260. Then, operation region determining section 240 acquires the user information through active window managing section 260.

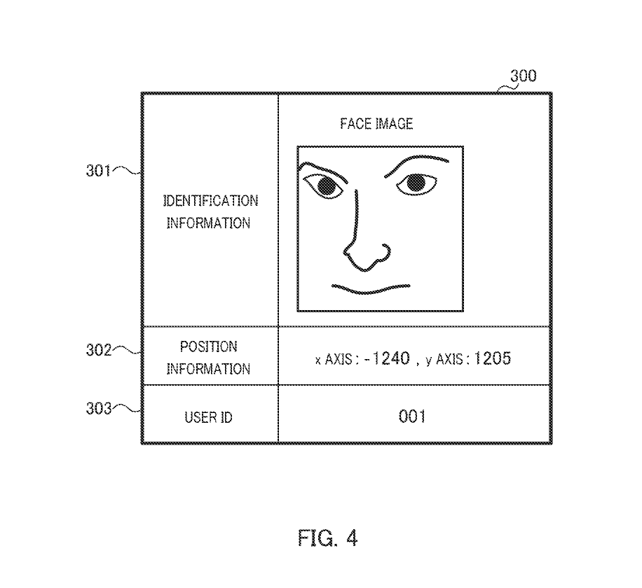

FIG. 4 is a diagram illustrating an exemplary content of the user information.

For example, user information 300 includes the user identification information 301, position information 302 indicating coordinates of the user's face on the screen, and user ID 303, which are described in association with one another for each user as illustrated in FIG. 4. Here, user ID 303 is information management number assigned to each user.

Active window managing section 260 sequentially determines whether or not the detected user is a new user based on identification information 301 of user information 300 received from detection section 230. When the detected user is determined to be a new user, active window managing section 260 newly generates association information to be described later, issues a new user ID, and outputs user information 300 to operation region determining section 240.

Then, in step S2000 of FIG. 3, operation region determining section 240 acquires the angle of the user based on position information 302 of user information 300, and determines an angle (direction) of an operation region relative to the center of the screen.

Then, in step S3000, operation region determining section 240 determines whether or not the user operation has been performed on the screen. For example, this determination can be made by determining whether or not the operation information output from window control section 270 has been forwarded from active window managing section 260.

When operation region determining section 240 determines that the user operation has been performed on the screen (YES in S3000), operation region determining section 240 proceeds to step S4000. However, when operation region determining section 240 determines that the user operation has not been performed on the screen (NO in S3000), operation region determining section 240 proceeds to step S5000.

In step S4000, operation region determining section 240 determines the position and the size according to content of the operation as an operation region for each user. Specifically, operation region determining section 240 adjusts the size of the operation region and determines the operation region with reference to a working area that has been actually used before, for example.

Meanwhile, in step S5000, operation region determining section 240 determines the position and the size that have been set in advance as the operation region for each user. For example, the position and the size that have been set in advance are the position and the size determined from the position of the user and the angle of the operation region when the user does not start to perform an operation yet. Further, the position and size that have been set in advance are the position and size that have been determined last, when the user continues to perform an operation. Thus, operation region determining section 240 can appropriately determine the operation region even before the user starts to perform an operation.

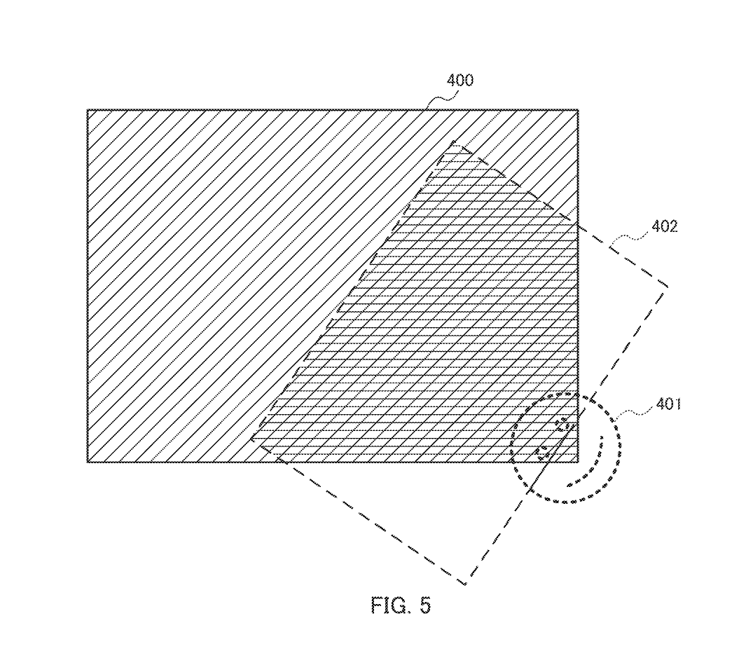

FIG. 5 is a diagram illustrating an exemplary method of determining an operation region.

As illustrated in FIG. 5, operation region determining section 240 determines rectangular region 402 of a predetermined size as the operation region with reference to the position and the angle of user 401 relative to screen 400, for example.

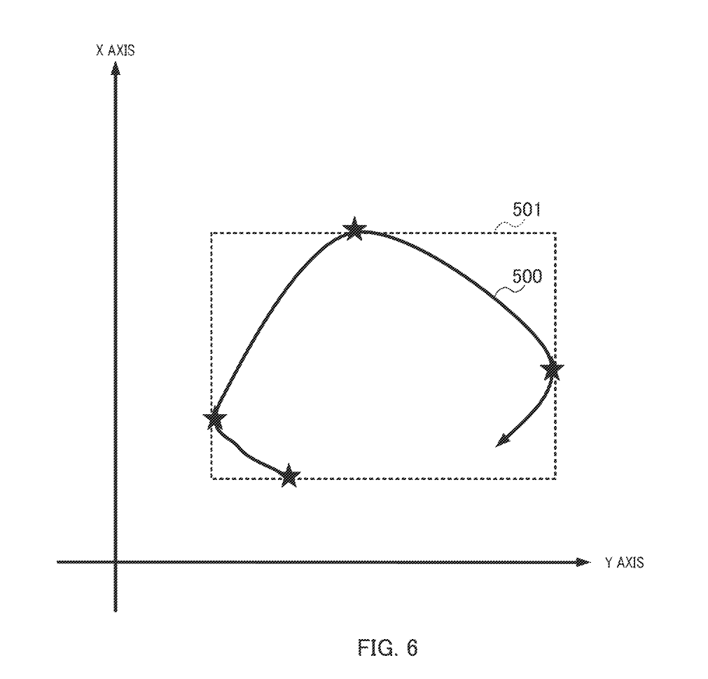

FIG. 6 is a diagram illustrating another exemplary method of determining an operation region.

As illustrated in FIG. 6, for example, operation region determining section 240 determines minimum rectangle 501 including trajectory 500 of a finger of the user as the operation region at the time of prior registration or during the operation. Further, at this time, operation region determining section 240 may determine the operation region so that the face position of the user is also included.

Then, in step S6000 of FIG. 3, operation region determining section 240 outputs operation information indicating the determined operation region to active window managing section 260. Then, active window managing section 260 adds the input operation information to the association information and holds the operation information.

In the case of an operation region of a new user, active window managing section 260 instructs window control section 270 to generate an active window screen (including a menu screen used to handle an active window) in the free space of the determined operation region. Then, active window managing section 260 acquires an ID of the generated window from window control section 270.

Then, in step S7000, terminal apparatus 200 performs a display state control process. The term “display state control process” refers to a process of determining the positions of the active windows so that the active windows operated by a plurality of users do not overlap each other. The details of the display state control process will be described later.

Then, in step S8000, window control section 270 generates an image in which the active windows are displayed at the positions determined by the display state control process, and outputs image data. As a result, the image in which each window is arranged at an angle that allows the user to view the screen with comfort, and the active windows do not overlap each other is displayed on the screen.

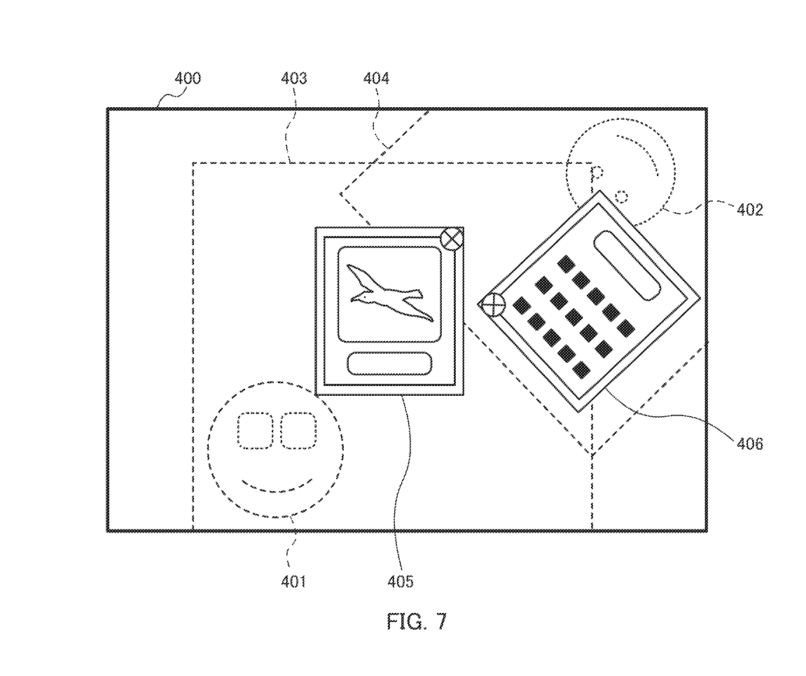

FIG. 7 is a diagram illustrating examples of the position of a user, the operation region, and the display screen.

In the present embodiment, as illustrated in FIG. 7, first user face 401 is positioned at the lower left side of screen 400, and second user face 402 is positioned at the upper right side of screen 400.

In the case of FIG. 7, rectangular region 403 horizontally positioned slightly below the center of the screen is determined to be the operation region of the first user, and rectangular region 404 obliquely positioned on the upper right of the screen is determined to be the operation region of the second user. Further, active window 405 associated with the first user and active window 406 associated with the second user are arranged at the same angles as those of corresponding rectangular regions 403 and 404, respectively.

Further, operation region determining section 240 may set the operation region to have a circular shape or any other shape other than a rectangular shape. Window control section 270 may arrange active windows 405 and 406 outside the corresponding operation regions. Further, window control section 270 may cause the operation regions to be invisible. Further, window control section 270 may reduce the amount of backlight for a region other than the operation region or turn off the backlight to reduce power consumption.

Then, in step S9000, active window managing section 260 determines whether an instruction to end the process performed by the user operation or the like has been given.

When determining that the instruction to end the process has not been given (NO in S9000), active window managing section 260 returns to step S1000. However, when determining that the instruction to end the process has been given (YES in S9000), active window managing section 260 ends the series of processes.

Further, active window managing section 260 generates association information based on various kinds of acquired information during the process, and manages the generated association information.

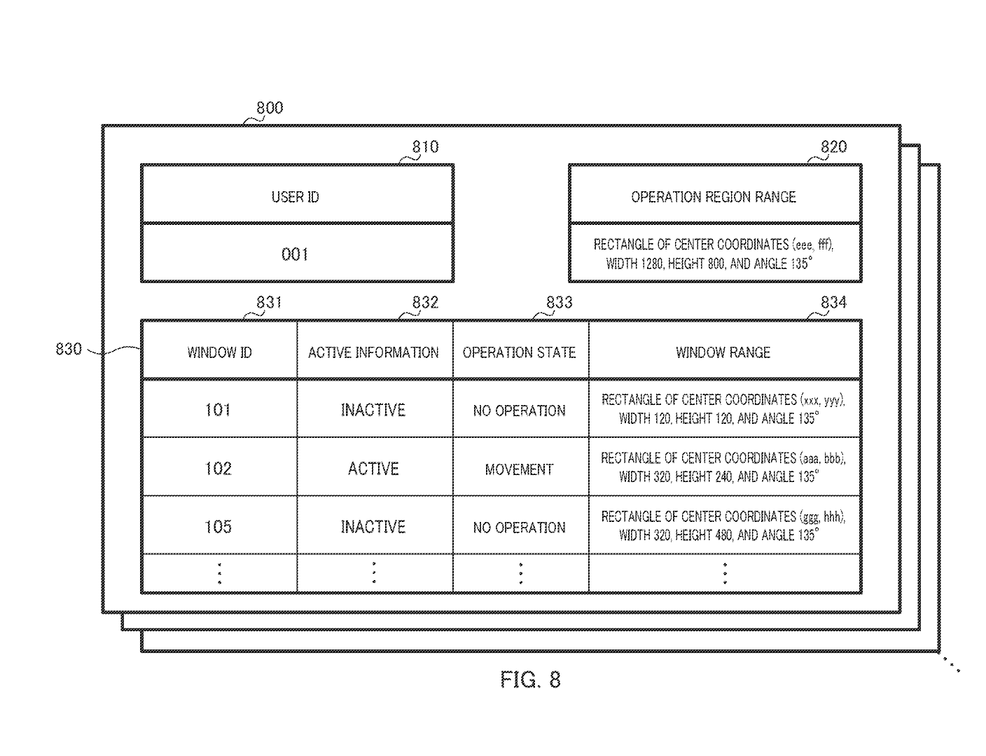

FIG. 8 is a diagram illustrating an exemplary content of the association information.

Referring to FIG. 8, association information 800 generated for each user includes user ID 810, operation region range 820, and window status 830. Further, window status 830 includes window ID 831, active information 832, operation state 833, and window range 834.

User ID 810 is the identification information of the user detected by detection section 230. Operation region range 820 is information indicating a range (a position, a size, and an angle) of the operation region determined by operation region determining section 240. Window ID 831 is identification information of the window generated by window control section 270. Active information 832 is information indicating whether or not a window is an active window. Operation state 833 is information indicating an operation state of a window. In the following description, the term “no operation” refers to a state where no operation has been performed for a predetermined period of time or more regardless of whether the window is an active window or an inactive window. Window range 834 is information indicating a range (a position, a size, and an angle) of a window region.

In other words, association information 800 includes an association between the user and an operation region, an association between the user and each window, ranges of the operation region and each window, and a status of each window. Here, the status of a window indicates whether or not the window is an active window and whether or not it is a no operation state, and includes the content of an operation.

Further, active window managing section 260 may further manage active window information including information related to all active windows, separately from association information 800.

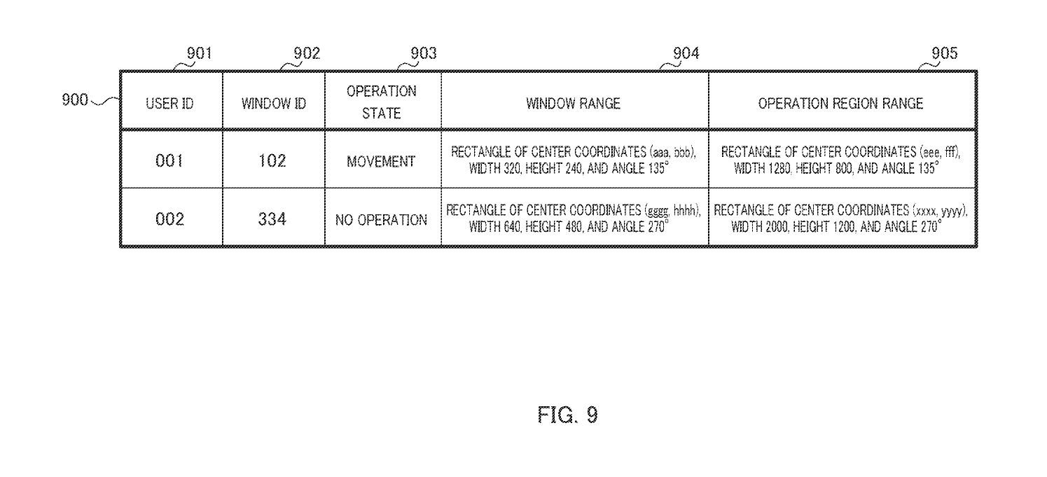

FIG. 9 is a diagram illustrating an exemplary content of the active window information.

As illustrated in FIG. 9, active window information 900 includes user ID 901, window ID 902, operation state 903, window range 904, and operation region range 905. These items of information correspond to user ID 810, window ID 831, operation state 833, window range 834, and operation region range 820 illustrated in FIG. 8 in order.

Terminal apparatus 200 performs the display state control process of step S7000 of FIG. 3 based on association information 800 (and active window information 900) managed by active window managing section 260.

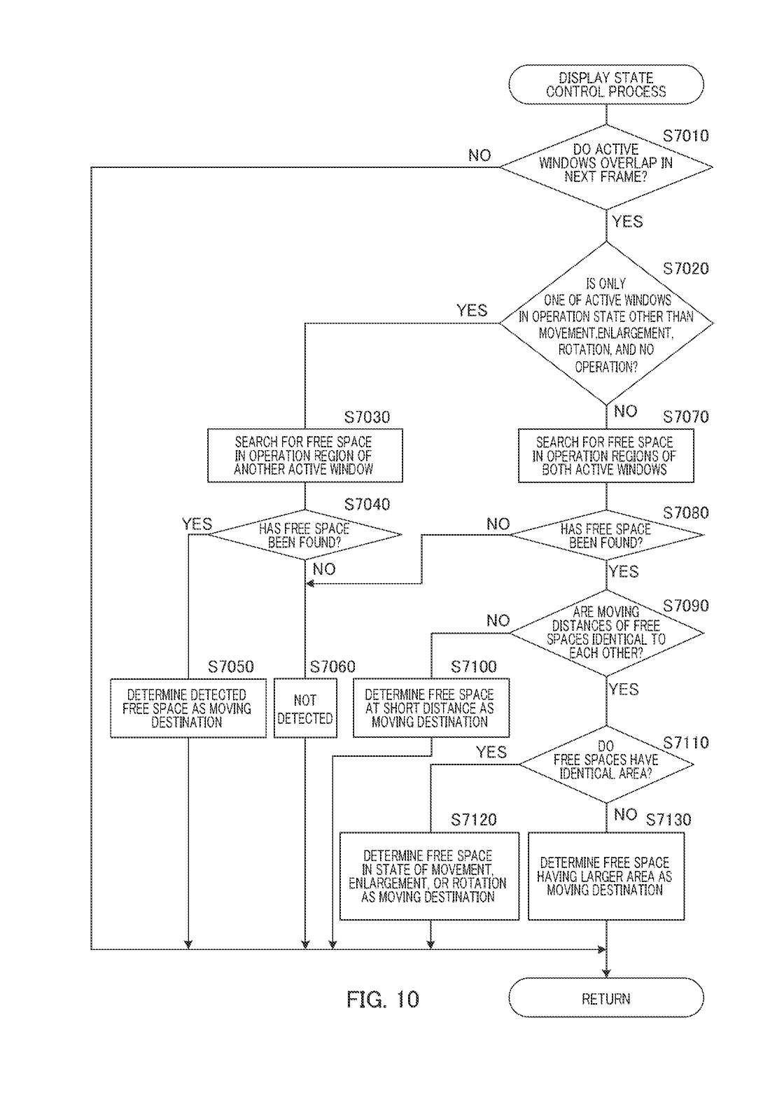

FIG. 10 is a flowchart illustrating an exemplary display state control process (step S7000 of FIG. 3).

First, in step S7010, active window managing section 260 determines whether or not the two active windows overlap each other in the next frame.

When determining that the two active windows do not overlap each other in the next frame (NO in S7010), active window managing section 260 directly returns to the process of FIG. 3.

However, when determining that the two active windows overlap each other in the next frame (YES in S7010), active window managing section 260 outputs active window information 900 (see FIG. 9) to free space determining section 250, and proceeds to step S7020.

In step S7020, active window managing section 260 determines whether or not an operation state of any one of the active windows is a state other than movement, enlargement, rotation, and no operation. For example, the operation states mentioned herein include is an operation state in which the window should not be moved as much as possible, e.g., inputting and/or editing of information such as a text, an image, or the like.

When the operation state of only one of the active windows is determined to be a state other than movement, enlargement, rotation, and no operation (YES in S7020), active window managing section 260 proceeds to step S7030. However, when the operation states of both of the active windows are determined to be a state other than movement, enlargement, rotation, and no operation (NO in S7020), active window managing section 260 proceeds to step S7070, which will be described later.

In other words, the processing proceeds to step S7070 when an operation involving movement such as movement, enlargement, or rotation has been performed on at least one of the active windows. Further, the processing proceeds to step S7030 when such an operation involving movement has not been performed on either one of the active windows.

Here, let us suppose that one of the active windows is in a state other than movement, enlargement, rotation, and no operation, and the other active window is in a state of movement, enlargement, rotation, or no operation. In the following description, the former is referred to as a “preferential active window,” and the latter is referred to as a “non-preferential active window.” Further, when both of the active windows are in a state of movement, enlargement, rotation, or no operation, both active windows are regarded as non-preferential active windows.

In step S7030, active window managing section 260 causes free space determining section 250 to search for a free space in the operation region of the user of the non-preferential (the other) active window.

Then, in step S7040, free space determining section 250 determines whether or not a free space has been found in the operation region of the user of the non-preferential active window.

When determining that a free space has been found (detected) (YES in S7040), free space determining section 250 proceeds to step S7050. However, when determining that a free space has not been found (NO in S7040), free space determining section 250 proceeds to step S7060.

In step S7050, free space determining section 250 notifies active window managing section 260 of a region involving the smallest moving distance among the detected free spaces. Active window managing section 260 determines the region notified by free space determining section 250 as a moving destination of the other active window. Then, active window managing section 260 instructs window control section 270 to perform such window movement using the window control information, and returns to the process of FIG. 3.

In step S7060, free space determining section 250 notifies active window managing section 260 that no free space has been detected (NOT DETECTED). Active window managing section 260 determines not to perform window movement. Then, active window managing section 260 instructs window control section 270 not to move the non-preferential (the other) active window using the window control information, and returns to the process of FIG. 3.

For example, let us suppose that the non-preferential active window have been automatically moved to a boundary of an operation by a flick operation. In this case, the non-preferential active window stops moving before overlapping with the active window of another user.

In step S7070, active window managing section 260 causes free space determining section 250 to search for a free space in the operation regions of the users of (both) the non-preferential active windows.

Then, in step S7080, free space determining section 250 determines whether or not a free space has been found in at least one of the operation regions of the users.

When determining that a free space has been found (detected) (YES in S7080), free space determining section 250 proceeds to step S7090. Further, when determining that no free space has been found (NO in S7080), free space determining section 250 proceeds to step S7060.

In step S7090, active window managing section 260 determines whether or not the moving distances are identical when free spaces are found in both operation regions and the corresponding active windows are moved.

When a free space has been found in only one of the operation regions or when the moving distances are different (NO in S7090), active window managing section 260 proceeds to step S7100. Further, when free spaces having the same moving distance have been detected (YES in S7090), active window managing section 260 proceeds to step S7110.

In step S7100, active window managing section 260 determines a free space having the smallest moving distance (at short distance) as the moving destination of the corresponding active window. Further, when only one free space has been detected, the free space is determined to be the moving destination of the active window. Further, active window managing section 260 instructs window control section 270 to perform such window movement using the window control information, and returns to the process of FIG. 3.

In step S7110, active window managing section 260 determines whether or not the free spaces having the same moving distance have an identical area. Here, for example, the area of the free space refers to the area of a region that does not overlap with the operation regions of the other users among free spaces.

When the free spaces having the same moving distance are determined to have an identical area (YES in S7110), active window managing section 260 proceeds to step S7120. However, when the free spaces having the same moving distance are determined to have a different area (NO in S7110), active window managing section 260 proceeds to step S7130.

In step S7120, active window managing section 260 determines a free space corresponding to an active window in an operation state of movement, enlargement, or rotation (that is, except no operation) to be the moving destination of the active window. Then, active window managing section 260 instructs window control section 270 to perform such window movement using the window control information, and returns to the process of FIG. 3.

Further, when both of the active windows are in an operation state of movement, enlargement, or rotation, active window managing section 260 may move both active windows or may move only one of the active windows according to the order of the window IDs or the like.

In step S7130, active window managing section 260 determines a free space having a larger area to be the moving destination of the corresponding active window. Then, active window managing section 260 instructs window control section 270 to perform such window movement using the window control information, and returns to the process of FIG. 3.

Through this operation, terminal apparatus 200 can manage each active window in association with the user operating the corresponding active window. Further, terminal apparatus 200 can monitor whether or not the active windows operated by the plurality of users overlap each other. Further, when the active windows overlap each other in the next frame, terminal apparatus 200 can search for a free space and move any one of the active windows to be positioned within the corresponding operation region.

Further, even when three or more active windows are simultaneously set as a processing target, and the three or more active windows overlap each other in the next frame, terminal apparatus 200 may process every pair of active windows sequentially.

In this case, for example, active window managing section 260 first performs window control for preventing two active windows from overlapping each other in the order of user IDs or window IDs.

Specifically, active window managing section 260 performs window control for preventing two active windows from overlapping each other such that the two active windows do not overlap with the one remaining active window. Then, active window managing section 260 determines the positions of the two active windows, and then performs window control for preventing the one remaining active window from overlapping with another. Then, after completing the determination on all the active windows that overlap, active window managing section 260 notifies window control section 270 of the determination results.

As described above, terminal apparatus 200 according to the present embodiment manages each active window in association with the user operating the corresponding active window, and prevents the active windows operated by the plurality of users from overlapping each other. Thus, terminal apparatus 200 can reduce interference among a plurality of users each working on a task, and allows a plurality of users to perform individual window operations with comfort on the non-divided screen. In other words, terminal apparatus 200 can smoothly and effectively perform simultaneous viewing or a collaborative work by a plurality of users, which can be realized only on the same panel.

### Embodiment 3

Embodiment 3 of the present invention is an example in which a display form of an active window is reconfigured.

<Configuration of Terminal Apparatus>

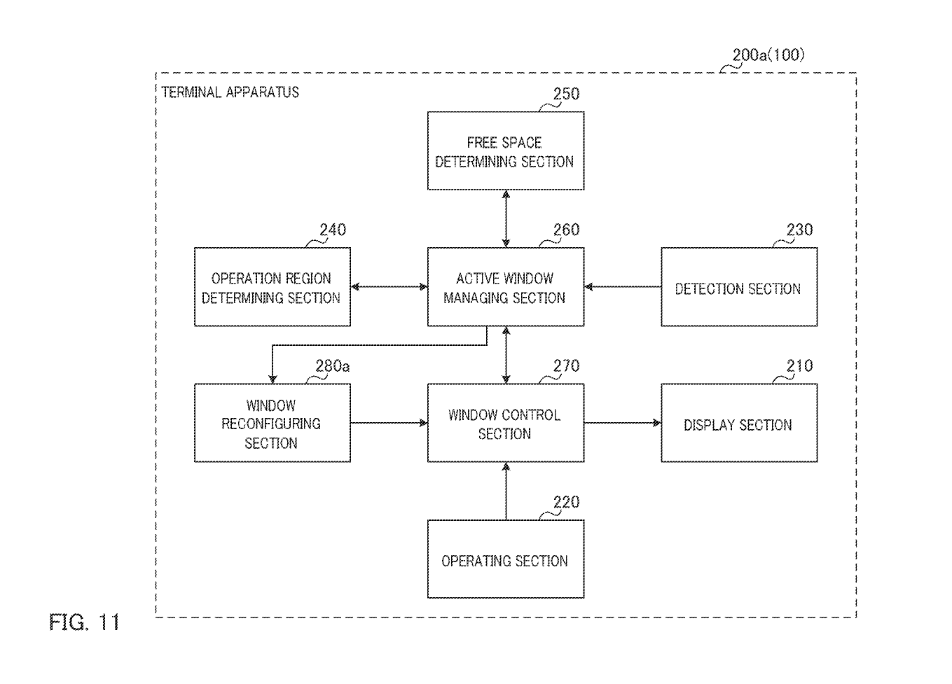

FIG. 11 is a block diagram illustrating an exemplary configuration of a terminal apparatus including a display apparatus according to the present embodiment, and corresponding to FIG. 2 of Embodiment 2. The same sections as those in FIG. 2 are denoted by the same reference numerals, and a description thereof is omitted.

As illustrated in FIG. 11, terminal apparatus 200a (display apparatus 100) further includes window reconfiguring section 280a in addition to the components of FIG. 2.

Window reconfiguring section 280a reconfigures a display form of an active window based on a positional relation between the active window and the operation region of the user. Specifically, window reconfiguring section 280a changes a position of a user interface region used to operate a window to a position where the user can easily perform an operation. Further, window reconfiguring section 280a switches a display form of an active window to be positioned in a corresponding operation region or closer to the corresponding operation region.

Here, let us suppose that terminal apparatus 200a displays a window that is implemented using a template by window control section 270. Further, the user interface area includes an operation button or a scroll bar, for example.

For example, active window managing section 260 sequentially monitors whether or not the active windows are positioned in the respective operation regions. Further, each time the active window is detected to be not positioned in the operation region, active window managing section 260 notifies window reconfiguring section 280a of the positional relation between the active window and the corresponding operation region together with the window ID.

Each time receiving the notification, window reconfiguring section 280a selects a window template that makes the user interface region positioned closer to the corresponding operation region. At this time, window reconfiguring section 280a selects a window template that makes the user interface area remain within the operation region if possible. Further, window reconfiguring section 280a designates a window ID, and instructs window control section 270 to perform switching to displaying of a window in the selected template.

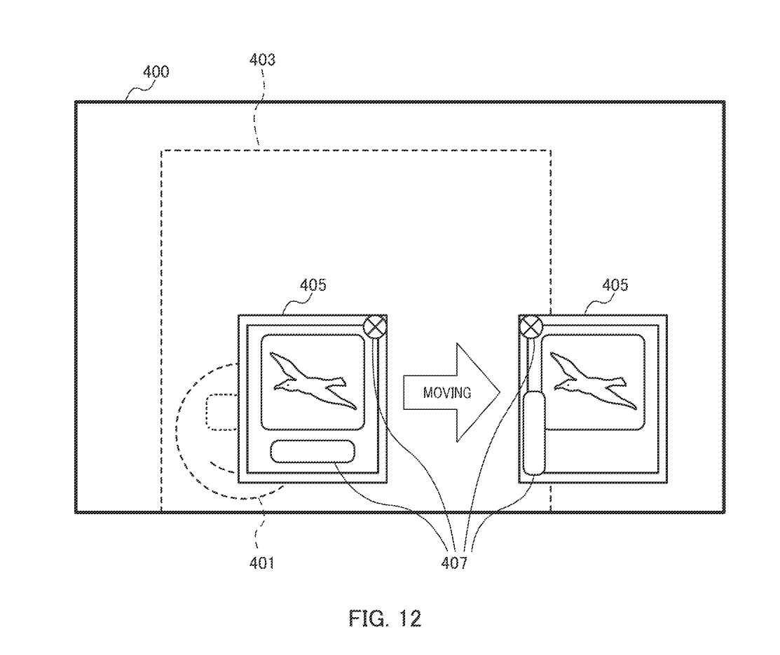

FIG. 12 is a diagram illustrating an exemplary reconfiguration of a display form, and corresponding to FIG. 7 of Embodiment 2.

In the present embodiment, as illustrated in FIG. 12, let us suppose that active window 405 operated by the first user has moved and protruded from the operation region of the first user (rectangular region) 403 on screen 400.

User interface area 407 of active window 405 was positioned at the upper right and the lower center before movement. However, in this state, active window 405 protrudes from operation region 403 after movement, and thus it is difficult for the first user to perform an operation.

In this regard, as described above, terminal apparatus 200a switches a display form of active window 405 so that user interface area 407 is positioned on the upper left and the lower left. In other words, user interface area 407 is reconfigured to be positioned within operation region 403.

As a result, even when active window 405 protrudes from operation region 403, the first user can operate active window 405 with comfort because user interface area 407 is positioned within operation region 403.

As described above, terminal apparatus 200a according to the present embodiment reconfigures the display form of the active window based on the positional relation between the active window and the operation region of the user. Thus, terminal apparatus 200a can improve comfort of each user with respect to the window operation. In other words, terminal apparatus 200a can increase a degree of freedom of movement or enlargement of the window screen within a user operable range for users.

In Embodiments 2 and 3 described above, a free space search range is not particularly mentioned, but free space determining section 250 may narrow down the search range to a region located in the moving direction when a window is moving.

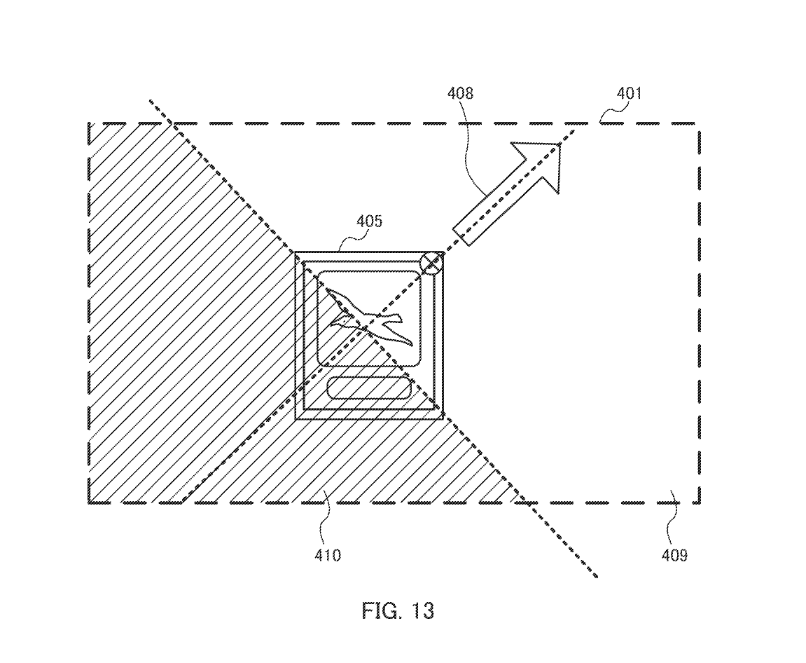

FIG. 13 is a diagram illustrating an exemplary free space search range, and corresponding to FIG. 7 of Embodiment 2.

As illustrated in FIG. 13, let us suppose that an operation is performed to move active window 405 positioned at the center of operation region 401 in upper right direction 408. Note that, the operation to move active window 405 in upper right direction 408 includes an operation to enlarge active window 405 in upper right direction 408 as well.

In this case, for example, active window managing section 260 notifies free space determining section 250 of information indicating moving direction 408. Free space determining section 250 sets only region 409 that is in moving direction 408 and that extends from the position of active window 405 in operation region 401 as the search range, and excludes region 410 in the 180-degree opposite direction from the search target.

As the free space search range is narrowed down as described above, the display apparatus can reduce a search processing load and improve a processing speed. Further, the display apparatus can prevent the moving direction of the window from significantly changing to the opposite direction, for example, and can further improve comfort of each user with respect to the window operation.

Further, an apparatus to which the present invention is applied is not limited to the above-described terminal apparatus including a touch panel and an LCD. The present invention can be applied to various kinds of display apparatuses allowing a plurality of users to operate a plurality of windows on a single screen, such as an apparatus using a screen for object projection.

In addition, the functional blocks used in the descriptions of the embodiments such as active window management section 260 may be implemented as software, as described above. In addition, these functional blocks may be typically implemented as LSI devices, which are integrated circuits. The functional blocks may be formed as individual chips, or a part or all of the functional blocks may be integrated into a single chip. The term “LSI” is used herein, but the terms “IC,” “system LSI,” “super LSI” or “ultra LSI” may be used as well depending on the level of integration.

In addition, the circuit integration is not limited to LSI and may be achieved by dedicated circuitry or a general-purpose processor other than an LSI. After fabrication of LSI, a field programmable gate array (FPGA), which is programmable, or a reconfigurable processor which allows reconfiguration of connections and settings of circuit cells in LSI may be used.

Should a circuit integration technology replacing LSI appear as a result of advancements in semiconductor technology or other technologies derived from the technology, the functional blocks could be integrated using such a technology. Another possibility is the application of biotechnology, for example.

A display apparatus of this disclosure is an apparatus that displays a plurality of windows on a single screen, the apparatus including: an active window managing section that manages an association between at least an active window among the plurality of windows and a user operating the active window; and a window control section that controls a display state of the active window based on the association, in which the window control section controls, when a plurality of the users are present, display positions of a plurality of the active windows so as to prevent the plurality of active windows corresponding to the plurality of users from overlapping each other.

In the display apparatus according to this disclosure: the active window managing section may further manage, for each of the users, an operation region of the user on the screen; and the window control section may move, when the plurality of active windows overlap each other, at least one of the plurality of active windows according to a predetermined rule that makes, in each of the operation regions, the active window of the user of the operation region positioned within the corresponding operation region of the user preferentially over the other active window.

In the display apparatus according to this disclosure, the predetermined rule may include a rule that prevents, in each of the operation regions, the active window of the user of the operation region positioned within the corresponding operation region from moving out of the corresponding operation region.

In the display apparatus according to this disclosure, the predetermined rule may include a rule that makes, in each of the operation regions, the active window of the user of the operation region not positioned within the corresponding operation region move to be positioned within the corresponding operation region.

In the display apparatus according to this disclosure, the predetermined rule may include a rule that determines, when a free space where any one of the windows is not displayed is present, preferentially at least one of a region that involves a shorter moving distance from the active window and a region that has a larger area among the free space, as a moving destination of the active window.

In the display apparatus according to this disclosure, the predetermined rule may include a rule that makes a display position of the active window of a predetermined type not move as much as possible, the active window of the predetermined type being an active window whose display position is to remain unchanged.

The display apparatus according to this disclosure may further include: a display section that displays the screen for the user; an operating section that receives an operation of the user on the screen; a detection section that detects a position of the user on the screen; an operation region determining section that determines the operation region for each of the users; and a free space determining section that determines the free space, in which: the operation region determining section determines the operation region based on at least one of the operation and the position of the user; and the active window managing section associates the active window with the user based on at least one of the operation and the position of the user.

The display apparatus according to this disclosure may further include a window reconfiguring section that reconfigures a display form of the active window based on a positional relation between the active window and the operation region of the user.

A display method according to this disclosure is a method of displaying a plurality of windows on a single screen, the method including: associating at least an active window among the plurality of windows with a user operating the active window; and controlling, when a plurality of the users are present, display positions of the plurality of active windows so as to prevent the plurality of active windows corresponding to the plurality of users from overlapping each other.

The disclosure of the specification, the drawings, and the abstract included in Japanese Patent Application No. 2012-007977 filed on Jan. 18, 2012 is incorporated herein by reference in their entirety.

### INDUSTRIAL APPLICABILITY

The present invention is useful as a display apparatus and a display method that allow a plurality of users to perform individual window operations with comfort on a non-divided screen. For example, the present invention is applicable to a variety of multi-user operable display apparatuses such as a tablet PC, a large display for desktop PC, a table-type touch panel LCD, and a game console including a large screen.

### REFERENCE SIGNS LIST

100 Display apparatus
200, 200a Terminal apparatus
210 Display section
220 Operating section
230 Detection section
240 Operation region determining section
250 Free space determining section
260 Active window managing section
270 Window control section
280a Window reconfiguring section

1. A display apparatus that displays a plurality of windows on a single screen, the apparatus comprising:
an active window managing section that manages an association between at least an active window among the plurality of windows and a user operating the active window; and
a window control section that controls a display state of the active window based on the association, wherein
the window control section controls, when a plurality of the users are present, display positions of a plurality of the active windows so as to prevent the plurality of active windows corresponding to the plurality of users from overlapping each other.

2. The display apparatus according to claim 1, wherein:
the active window managing section further manages, for each of the users, an operation region of the user on the screen; and
the window control section moves, when the plurality of active windows overlap each other, at least one of the plurality of active windows according to a predetermined rule that makes, in each of the operation regions, the active window of the user of the operation region positioned within the corresponding operation region of the user preferentially over the other active window.

3. The display apparatus according to claim 2, wherein the predetermined rule includes a rule that prevents, in each of the operation regions, the active window of the user of the operation region positioned within the corresponding operation region from moving out of the corresponding operation region.

4. The display apparatus according to claim 3, wherein the predetermined rule includes a rule that makes, in each of the operation regions, the active window of the user of the operation region not positioned within the corresponding operation region move to be positioned within the corresponding operation region.

5. The display apparatus according to claim 4, wherein the predetermined rule includes a rule that determines, when a free space where any one of the windows is not displayed is present, preferentially at least one of a region that involves a shorter moving distance from the active window and a region that has a larger area among the free space, as a moving destination of the active window.

6. The display apparatus according to claim 2, wherein the predetermined rule includes a rule that makes a display position of the active window of a predetermined type not move as much as possible, the active window of the predetermined type being an active window whose display position is to remain unchanged.

7. The display apparatus according to claim 1, further comprising:
a display section that displays the screen for the user;
an operating section that receives an operation of the user on the screen;
a detection section that detects a position of the user on the screen;
an operation region determining section that determines the operation region for each of the users; and
a free space determining section that determines the free space, wherein:
the operation region determining section determines the operation region based on at least one of the operation and the position of the user; and
the active window managing section associates the active window with the user based on at least one of the operation and the position of the user.

8. The display apparatus according to claim 1, further comprising a window reconfiguring section that reconfigures a display form of the active window based on a positional relation between the active window and the operation region of the user.

9. A display method of displaying a plurality of windows on a single screen, the method comprising:
associating at least an active window among the plurality of windows with a user operating the active window; and
controlling, when a plurality of the users are present, display positions of the plurality of active windows so as to prevent the plurality of active windows corresponding to the plurality of users from overlapping each other.
